(19) United States
(12) Patent Application Publication
(10) Pub. No.: US 2006/0212411 A1
(43) Pub. Date: Sep. 21, 2006

(54) Combination newstand and advertising kiosk and method of conducting business

(76) Inventor: Edmund George Gabay JR., Silver Spring, MD (US)

Correspondence Address: Edmund George Gabay, Jr., 8711 Reading Road, Silver Spring, MD, 20901, US

(21) Appl. No.: 11/375,398

(22) Filed: Mar. 15, 2006

Related U.S. Application Data
(60) Provisional application No. 60/661,948, filed on Mar. 16, 2005.

(51) Int. Cl. G06F 17/00

(52) U.S. Cl. 705/500

(57) ABSTRACT

A kiosk-like structure that simultaneously houses a bank or banks of modular news-boxes and one or more advertising display cases thus manifesting a business method therefor. A structure fabricated from galvanized structural steel members that are that are secured together by welding, bolts or screws. The invention will simultaneously support a bank or banks of modular type news-boxes and advertising display cases. Structure will have a roof of various materials to shield advertising display cases and news-boxes from direct exposure to various weather conditions. Structural steel members of the device may be exposed to plain view and only finished with paint or may be concealed behind ornamental housing of appropriate material. The device will be secured to a firm hard surface such as a concrete sidewalk with the use of anchor bolts or similar means.

### FIELD OF THE INVENTION

The present invention relates to a new type of device that combines banks of modular news boxes and advertising display space to form a compact, aesthetically pleasing structure that is particularly adapted for use in an outdoor environment and to a business method incorporating the use of such device.

### BACKGROUND OF THE INVENTION

The nationwide problem of the proliferation of news-boxes has spread within each City of the United States like an epidemic. Freestanding news-boxes clutter the downtown areas of all major cities in America not only creating an eyesore on every corner but also impeding pedestrian traffic. This problem of proliferation of untidy groups of news-boxes in public areas is an issue for which no jurisdiction has found a completely workable solution without infringing on First Amendment rights of publishers. The increase in the appearance of news-boxes around downtown districts coincides with the increase in various different publications and special interests. Their unsightly appearance has to do with the different colors, styles and sizes of the boxes not to mention their numbers in certain high traffic areas.

The news-boxes have also attracted taggers and generators of graffiti. Unfortunately, circulation managers do not pay much attention to the maintenance of the boxes and removal of graffiti but rather concentrate on making sure the boxes are stocked regularly.

Various groups have appeared in several big cities with the mission of cleaning up the mess but the solutions are more of a band aid. Some groups have advocated using modular boxes stacked on pedestals. Although these are an improvement they are still not very attractive. Other groups have tried rearranging the boxes to look more uniform and orderly with limited success. Yet other municipalities have tried limiting the amount of boxes on a particular corner by using certain size metal corrals.

City Councils have tried to regulate the placement of news boxes with success in some cases and in other cases causing litigation by publisher attorneys claiming restriction or violation of First Amendment rights. This makes the issue all the more delicate and frustrating for City officials, neighborhood groups and merchants.

On the other hand, numerous styles and types of advertising kiosks have been designed and constructed up to the present time. An advertising kiosk basically comprises a self supporting, free standing structure such as a frame, pedestal or hollow housing mounted on some type of surface, e.g. a concrete pavement. The support structure serves to hold a panel in or on which a sheet of advertising copy, e.g. a photograph or other graphics or text, may be mounted for viewing by persons passing by the kiosk Other types of kiosks may support equipment or devices such as ATM machines or digital computer screens for interaction with persons seeking information or services.

Advertising kiosks suited for outdoor use are usually constructed of similar materials but have taken a variety of shapes. Some examples of prior art are discussed in the paragraphs to follow and their differences from the present invention are indicated.

Display structures for the purpose of advertising have been the subject of earlier patent documents. Of particular interest is U.S. Pat. No. 5,542,554 issued to Resnick, which discloses a molded plastic housing featuring illuminated sections for advertising and vertically spaced compartments for displaying merchandise and other items. The display housing is formed as two units secured to each other and supported by a base member. With reference to the present invention Resnick's patent does not specifically support the use of modular news-boxes nor does it appear to be conceived with that intent.

Furthermore, U.S. Pat. No. 4,471,586 issued to Shuch et al, shows a kiosk for housing newspapers, magazines, and other merchandise comprising a cell of trapezoidal shape, the small base of which forms the rear wall of the unit and the large base forming the front wall. The unit features a supporting structure formed by at least four main posts interconnected by cross members and a roof framework.

In addition, U.S. Pat. No. 6,802,143 B1, issued to Rachowitz et al, describes an assembly for advertising material that comprises a rotating advertising display unit having independent display modules that lights and advertising materials.

U.S. Design Pat. Des. 410,288, issued to Kleihues, depicts an ornamental design for a newsstand.

None of the patents uncovered in the search disclose a kiosk design or business method that employs all the three critical elements of the present invention namely, (i) a structural framework to which is attached (ii) one or more advertising display units while simultaneously supporting one or more banks of modular type news-boxes.

### BRIEF DESCRIPTION OF THE DRAWINGS

The foregoing and other objects, aspects and advantages will be better understood from the following embodiment description with reference to the drawings, in which:

FIG. 1 is a flow diagram showing a method of doing business according to the preferred embodiment of the present invention.

FIG. 2 shows a three dimensional view of the preferred embodiment of the device.

FIG. 3 shows a front view of the preferred embodiment of the device

FIG. 4 is a section through the device through the advertising display cabinets.

FIG. 5 shows a vertical section through the lower portions of the device.

FIG. 6. shows a vertical section through the roof assembly of the device.

### DETAILED DESCRIPTION OF PREFERRED EMBODIMENT OF THE INVENTION

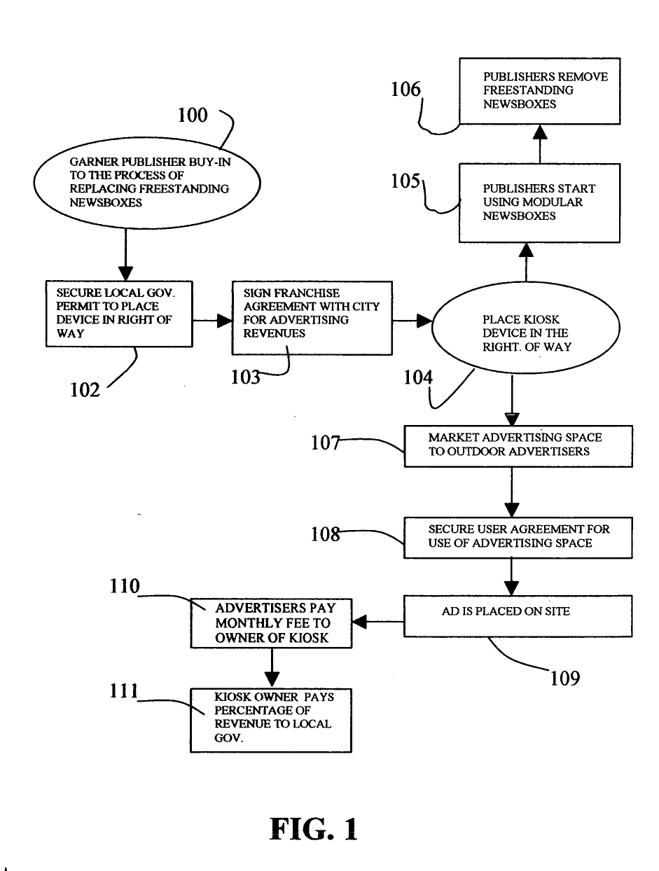

The present invention provides an aesthetically pleasing solution to the cluttering appearance of freestanding news-boxes in the publics right of way of jurisdictions around the United States. Referring to the flow diagram in FIG. 1 the first step 102 of the business process would be to secure permission from local jurisdiction to place the device at various locations wherever large groups of freestanding news boxes are found. A significant motivation for the public agency to buy into this process is the potential for each structure to generate a small revenue stream. Additionally, depending on how many boxes are placed within the right of way the resulting revenues garnered could be quite significant. It would be a source of income that did not involve taxpayers money or fees charged for public services.

Circulation manager or other decision makers within affected newspaper publishing organizations such as the Washington Post would also be contacted 101 in order to gain their consent to the process. The motivation for the publishers to buy in to the process 101 is the fact the they will not have to pay for or maintain the modular news-boxes. Also, by participating in and facilitating this process to some extent the newspaper publisher assist in the transformation of urban areas in tidier environments.

Once approval 102 is granted for the device to be place in the public right of way 104 the modular newspaper boxes are assigned to various interested newspaper publishers provided they consent to the process 101 and remove their free standing news-boxes 106.

As previously stated, the advertising display space on each device place in the public right of way is a potential revenue generator for the public agency and the device owner. The owner operator of the structure will actively market the available space 107 and, once securing an interested client, will enter into an agreement 108 that will stipulate a monthly or yearly fee 110 for the advertising company to use the space or spaces 109. In turn, the owner of the device would, through a prior contractual agreement 103 pay a percentage of the revenues to the municipality, public agency in control of the right of way or property where the device is located 111.

Currently, newspaper publishers supply and maintain their own newspaper boxes although vigilance and care of the boxes has been lacking in some cases. The present invention makes modular news-boxes available, free of charge, to publishers. Also, since maintenance and repair of the device will be the responsibility of the owner, the publishers stand to save on their operating expenses.

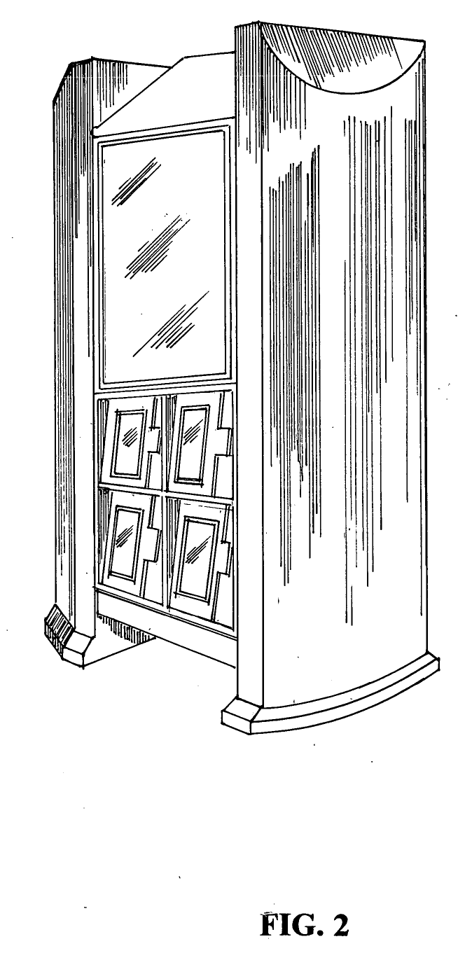

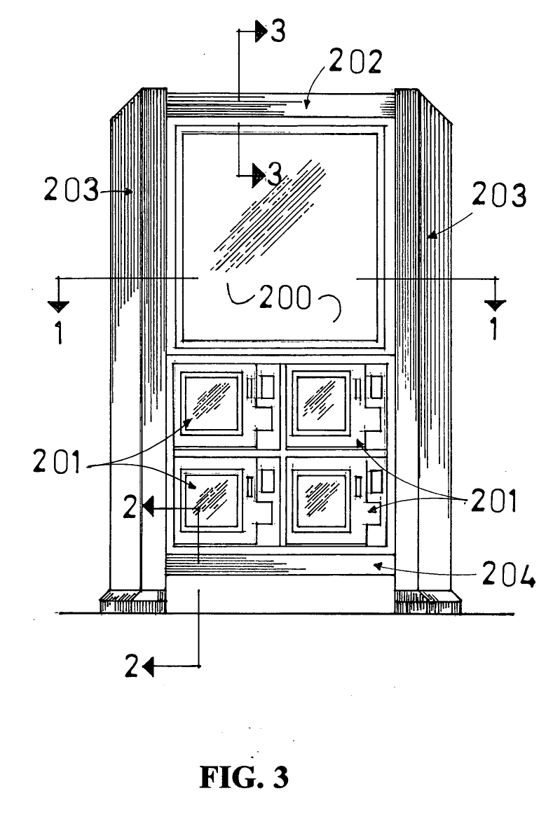

Referring now to the drawings, and more particularly, FIG. 2 and FIG. 3 we see an exemplary embodiment of the invention. FIG. 2 shows the typical elements of the invention which include a space or cabinet for display advertising, 200 which can be located above or to the side of banks of modular news-boxes 201.

The assembly is sheltered by a galvanized steel or anodized aluminum roof 202 that is sloped primarily for the purpose of deflecting rain or snow away from the advertising display cases 200 and modular news-boxes 201. Alternatively, the roof 202 could be formed wholly or partly of other materials such as molded plastic or Lexan.

On either side of the advertising display case/modular news-box 200/201 assembly are galvanized steel housings or shells 203 that are secured to concealed structural framing 400. The exterior wall housings or shells 203 are fabricated from 14 ga galvanealed steel sheeting, the ends of which are wrapped around two sides of the support columns 400 and secured thereto by means of rivets or sheet metal screws. The metal shells 203 are primarily ornamental in function providing a clean, neat and aesthetically pleasing appearance. The metal shells 203 also perform the utilitarian function of concealing less attractive structural framing 400,401,500,501 and electrical wiring.

Both the exterior wall housings 203 and the galvanealed roof covering 202 can be finished with a variety of treatments such as automotive quality acrylic enamel, baked enamel finish or polished steel.

It is appropriate at this juncture to note that a fully functioning device could be fabricated without the use of the steel housings. The exposed structural members would, in that case be treated with an appropriate and attractive finish such as a baked enamel paint finish. Wiring and cables would be concealed within the structural members of the device.

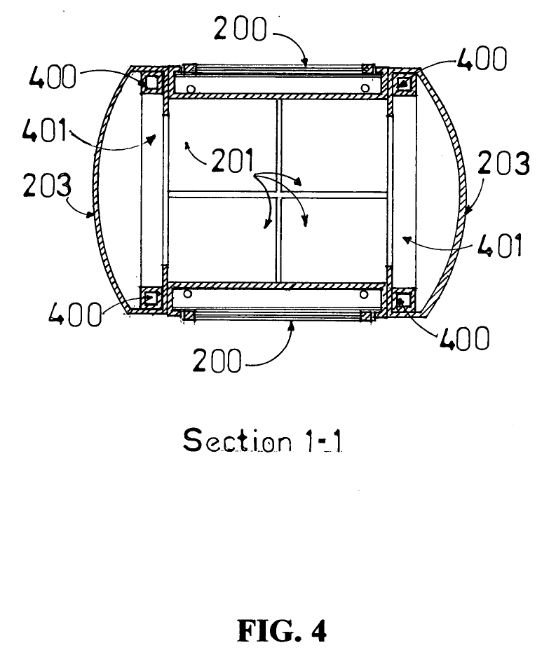

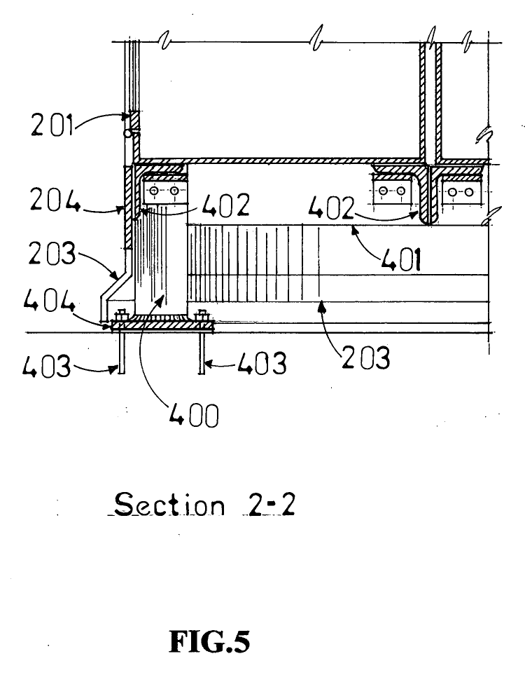

Referring now to FIG. 4 and FIG. 5, the structural framing that supports the news-boxes 201, advertising display cases 200 and metal shells 203 is comprised of four galvanized steel support columns 400 that are anchored to a solid, firm surface such as a concrete sidewalk. Each column 400 is secured to the surface by means of at least four anchor bolts 403 that run through corresponding holes in a steel base plate 404 at the bottom of each support column 400. The support columns 400 in turn are area connected together by galvanized steel channels or beams 401 running parallel to the long dimension of each ornamental shell. These steel beams or channels 401 in turn support four steel angles 402 upon which the modular news-boxes 201 sit. The steel angles 402 are bolted or welded to the steel channels 401.

Internally illuminated advertising display panels 200 are attached to the steel support columns with steel flanges or angles screwed into each element and are located directly above the modular news-boxes 201. Advertising panels are a common means of outdoor advertising as can be seen in many new bus shelters that incorporate them. The advertising panels or display cases 200 are separately fabricated with all necessary electrical components to illuminate advertising copy. Advertising panels or display cases 200 will have a “Plexiglass” or “Lexan” face for glazing and wiring is within the kiosk's structural members with access holes and cover plates for appearance and ease of installation and maintenance.

Alternatively, the advertising display panels 200 may be located on the sides of the kiosk structure or on the rear side in cases modular news-boxes 201 are only accessed from one side.

Also, the advertising display panels, where feasible, may be substituted with digital type display screens of comparable size to the illuminated type.

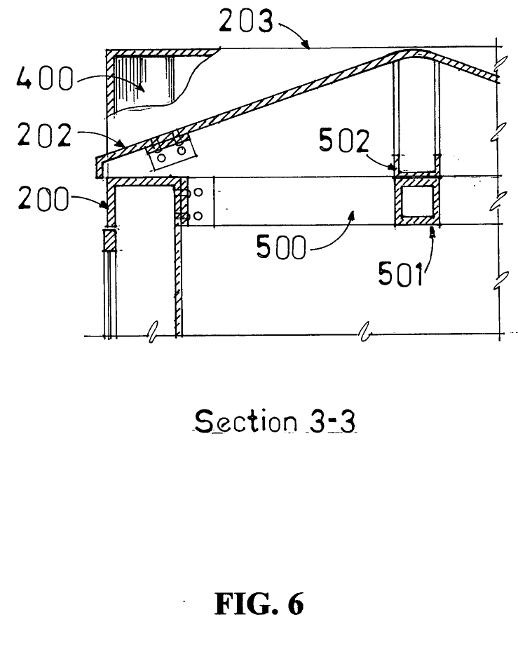

Referring again to FIG. 6 the support columns 400 are connected to each other in pairs, at the roof level by galvanized steel beams or channels 500 running parallel to the long dimension of the steel housings or shells 203. The steel channels 500 are in turn connected to each other, at their mid points, by another steel channel running 501 perpendicular to the first two channels 500. The connecting channel 501 gives the overall structure additional rigidity at the roof level. On top of the connecting channel 501, 12 ga. or 10 ga. steel studs 502 have been attached with screws to support a galvanized steel or anodized aluminum roof 202. The roof material 202 is also secured to the studs 502 and to other areas of the structure with flanges and sheet metal screw or other appropriate means.

It will further be appreciated by those persons skilled in the art, that the embodiments described herein are merely exemplary of the principles of the invention and that many modifications and variations are possible without departing from the spirit and scope of the invention.

1. A method of doing businesses, comprising
a device that provides an aesthetically pleasing solution to the disorganized and objectionable appearance of the groups of traditional freestanding news-boxes by replacing them at their most populous locations;
a device that combines modular type news-boxes and outdoor display advertising in a single structure using a support framework.

2. A method of doing business as in claim 1, wherein revenue is generated for both the jurisdiction where the structure is located and for the owner of the device by incorporating the use of display advertising and;
a new avenue for outdoor advertisers is created in order to place display advertising before thousands of eyes everyday and;
an expense free location is provided to newspaper publishers for distribution of their material.
